(19) United States
(12) Patent Application Publication
(10) Pub. No.: US 2009/0134839 A1
(43) Pub. Date: May 28, 2009

(54) ALTERABLE BATTERY CHARGER

(75) Inventor: Hsi-Tung LIN, TAIPEI CITY (TW)

Correspondence Address: Chih Feng Yeh;BRIAN M. MCINNIS, 12th Floor, Ruttonjee House, 11 Duddell Street, Hong Kong, HK

(73) Assignee: Hsi-Tung LIN, TAIPEI CITY (TW)

(21) Appl. No.: 12/242,928

(22) Filed: Oct. 1, 2008

(30) Foreign Application Priority Data
Nov. 28, 2007 (TW) 96220136

(51) Int. Cl. H02J 7/00

(52) U.S. Cl. 320/110

(57) ABSTRACT

An alterable battery charger for charging a rechargeable battery is disclosed. The alterable battery charger includes a clamp for clamping the rechargeable battery, a first interface disposed on the clamp to connect to an external power, and two conductive pieces disposed in the clamp. At least one of the conductive pieces is pivoted on the clamp, and the alterable battery charger does not have a built-in AC/DC adapter.

### RELATED APPLICATIONS

This application claims priority to Taiwan Application Serial Number 96220136, filed Nov. 28, 2007, which is herein incorporated by reference.

### BACKGROUND

1. Field of Invention

The present invention relates to a battery charger. More particularly, the present invention relates to a battery charger for charging different rechargeable batteries.

2. Description of Related Art

Since the introduction of personal computer (PC) systems, different kinds of electronic products have been invented. PC systems have evolved into modern electronic products that are now able to perform many functions, including playing video and audio signals, processing images, and network communications. However, due to their large volumes and weights, many portable electronic devices with different functions have been introduced, such as MP3 music players, digital cameras, mobile phones, and personal digital assistants (PDA).

The rechargeable battery has a large electricity capacity and a long use time and has been widely used in various portable electronic devices. Different kinds of portable electronic devices have their respective rechargeable batteries, such as a nickel-cadmium cell, a nickel-metal-hydride battery (NiMH battery), or a lithium cell. The rechargeable batteries need to be charged by the corresponding battery charger.

However, people may have more than one portable electronic device, those portable electronic devices further have their own battery charger to charge the rechargeable battery thereof. The plural portable electronic devices and the battery chargers thereof are not easy to carry and would reduce the convenience of the portable electronic devices.

For the forgoing reasons, there is a need to reduce the number of the battery chargers when carrying the portable electronic devices.

### SUMMARY

The present invention is directed to an alterable battery charger that satisfies this need to reduce the number of the battery chargers when carrying the portable electronic devices.

The invention provides an alterable battery charger to charge different kinds of rechargeable batteries. The rechargeable battery has a first electrode and a second electrode. The alterable battery charger includes a clamp for clamping the rechargeable battery, a first interface disposed on the clamp to connect to an external power, and two conductive pieces disposed in the clamp. At least one of the conductive pieces is pivoted on the clamp, and the alterable battery charger does not have a built-in AC/DC adapter.

The alterable battery charger further includes a printed circuit board disposed in the clamp and connecting to the first interface and the conductive pieces. The alterable battery charger further includes a plurality of light-emitting devices disposed on a surface of the clamp. The light-emitting devices are controlled by the printed circuit board. The printed circuit board includes a first protect circuit connecting to the first interface and the conductive pieces to prevent the rechargeable battery from overcharging or over discharging. The printed circuit board includes a switch circuit connecting to the first interface and the conductive pieces to determine the electricity of the first electrode and the second electrode and switch the electricity of the conductive pieces. The printed circuit board includes a second protect circuit connecting to the conductive pieces to prevent the conductive pieces from short circuit. The first interface comprises a universal serial bus plug or a mini universal serial bus plug.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a schematic diagram of a conventional rechargeable battery;

FIG. 2A illustrates a top-view diagram of an embodiment of the alterable battery charger of the invention;

FIG. 2B illustrates a side-view diagram of the embodiment of the alterable battery charger of the invention; and

FIG. 3 illustrates a schematic diagram of another embodiment of the alterable battery charger of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

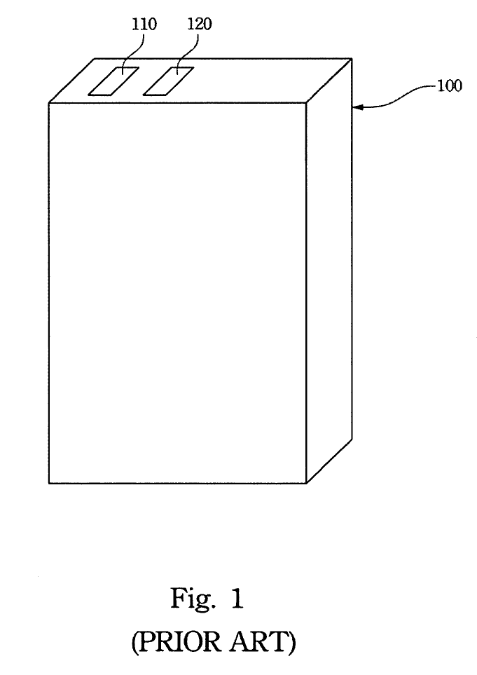

Refer to FIG. 1. FIG. 1 illustrates a schematic diagram of a conventional rechargeable battery. The rechargeable battery 100 can be a nickel-cadmium cell, a nickel-metal-hydride battery (NiMH battery), or a lithium cell. The rechargeable battery 100, which has a large electricity capacity and a long use time, has been widely used in various portable electronic devices, such as digital cameras, mobile phones, and personal digital assistants (PDA).

The rechargeable battery 100 has a first electrode 110 and a second electrode 120. The first electrode 110 and the second electrode 120 have opposite electricity. For example, if the first electrode 110 has positive electricity, the second electrode 120 could have negative electricity. A particular battery charger is required when the rechargeable battery 100 is charged. Different kinds of rechargeable batteries and the battery chargers thereof could not be compatible in the prior art, and that makes the portable electronic devices uneasy to carry.

The present invention provides an alterable battery charger to fit different kinds of rechargeable batteries to reduce the number of the battery chargers.

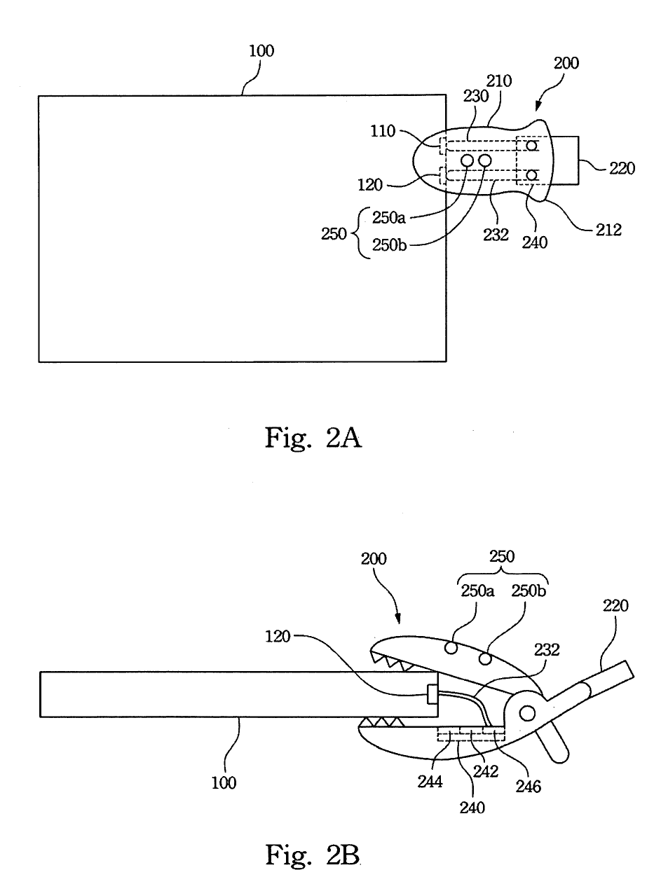

Refer to FIG. 2A and FIG. 2B simultaneously. FIG. 2A illustrates a top-view diagram of an embodiment of the alterable battery charger of the invention. FIG. 2B illustrates a side-view diagram of the embodiment of the alterable battery charger of the invention. The rechargeable battery charger 200 includes a clamp 210, a first interface 220, and two conductive pieces 230, 232. The alterable battery charger 200 does not have a built-in AC/DC adapter.

The material of the clamp 210 is an insulating material. The rechargeable battery 100 can be clamped by the clamp 210. The first interface 220 is disposed on the clamp 210. The clamp 210 has a torsion portion 212, and the first interface 220 can be disposed on the torsion portion 212. The first interface 220 connects to an external power.

The conductive pieces 230, 232 are disposed on the clamp 210. The conductive pieces 230, 232 are disposed inside of the clamp 210, and an end of the conductive pieces 230, 232 is connected to the first interface 220. At least one of the conductive pieces 230, 232 is pivoted on the clamp 210. The material of the conductive pieces 230, 232 can be metal. The material of the conductive pieces 230, 232 can be flexible material.

The conductive pieces 230, 232 are both pivoted in the clamp 210, and the distance between the conductive pieces 230, 232 can be altered to be as same as the distance between the first electrode 110 and the second electrode 120 of the rechargeable battery 100, which is clamped by the clamp 210. The position of the conductive pieces 230, 232 can be altered to fit different kinds of rechargeable batteries 100, thus the alterable battery charger 200 can charge different kinds of rechargeable batteries 100.

The first interface 220 can be a universal serial bus plug or a mini universal serial bus plug. The external power of this embodiment can be a direct current. The direct current can be provided by a desktop computer or a laptop computer. The first interface 220 can be inserted into the socket of the computer.

The direct current provided by the computer can be sent to the conductive pieces 230, 232 via the first interface 220, and the direct current is sent to the first electrode 110 and the second electrode 120 of the rechargeable battery 100 via the conductive pieces 230, 232 to charge the rechargeable battery 100.

The alterable battery charger 200 further includes a printed circuit board 240. The printed circuit board 240 is disposed in the clamp 210. The printed circuit board 240 is electrically connected to the first interface 220. The printed circuit board 240 is electrically connected to the conductive pieces 240.

The alterable battery charger 200 further includes several light-emitting devices 250 disposed on the clamp 210. The light-emitting devices 250 are controlled by the printed circuit board 240 as the indication lights to perform different functions. The light-emitting device 250a can be lit when the conductive pieces 230, 232 touch the first electrode 110 and the second electrode 120. The light-emitting device 250b can be flickered when the rechargeable battery 100 is charged. The light-emitting device 250b can be lit when the rechargeable battery 100 has been charged. These functions can be provided by single light-emitting device 250 or be provided by the group of the light-emitting devices 250.

The printed circuit board 240 includes a switch circuit 242 electrically connecting to the first interface 220 and the conductive pieces 230, 232. The switch circuit 242 determines the electricity of the first electrode 110 and the second electrode 120. The switch circuit 242 could further switch the electricity of the conductive pieces 230, 232 according to the first electrode 110 and the second electrode 120 touched by the conductive pieces 230, 232. Therefore, the direct current can send to the corresponding electrodes and be stored in the rechargeable battery 100 via the conductive pieces 230, 232.

The switch circuit 242 could determine the electricity of the first electrode 110 and the second electrode 120 and switch the electricity of the conductive pieces 230, 232 automatically when the conductive pieces 230, 232 touch the first electrode 110 and the second electrode 120. The switch circuit 242 could also determine the electricity of the first electrode 110 and the second electrode 120 and switch the electricity of the conductive pieces 230, 232 manually when the conductive pieces 230, 232 touch the first electrode 110 and the second electrode 120.

The printed circuit board 240 includes a first protect circuit 244 electrically connecting to the first interface 220 and the conductive pieces 230, 232. The first protect circuit 244 can prevent the rechargeable battery 100 from overcharging or over discharging. The first protect circuit 244 could stop the alterable battery charger 200 charging the rechargeable battery 100 to protect the rechargeable battery 100 when the first protect circuit 244 detects that the rechargeable battery 100 has been full charged. The first protect circuit 244 could also stop the rechargeable battery 100 discharging when the rechargeable battery 100 has been discharged empty.

The printed circuit board 240 includes a second protect circuit 246 electrically connecting to the conductive pieces 230, 232 to prevent the damage caused by the unexpected contact of the conductive pieces 230, 232.

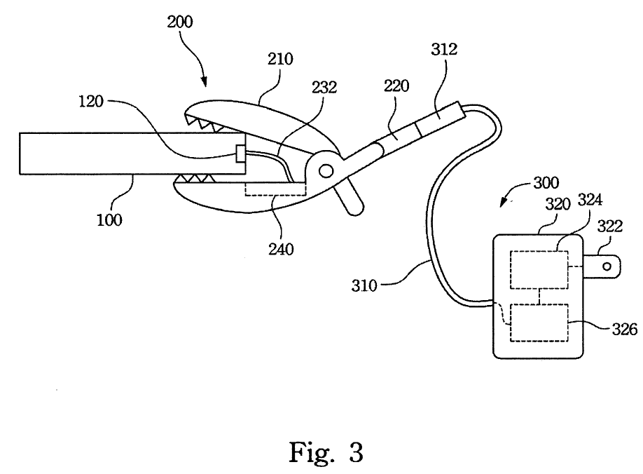

Refer to FIG. 3. FIG. 3 illustrates a schematic diagram of another embodiment of the alterable battery charger of the invention. The conductive piece 230 (not shown) is fixed on the clamp 210, and the conductive piece 232 is pivoted on the clamp 210. The distance between the conductive pieces 230, 232 can be altered manually to be as same as the distance between the first electrode 110 (not shown) and the second electrode 120.

The external power in this embodiment can-be an alternating current. The alterable battery charger 200 can externally connect to an adapter 300. The adapter 300 includes a wire 310 and an adapter unit 320. The wire 310 includes a second interface 312, which has the same standard interface as the first interface 220. The alterable battery charger 200 can connect to the adapter 300 by coupling the first interface 220 to the second interface 312.

The adapter unit 320 has a plug 322 to insert into the AC socket. The adapter unit 320 includes an AC/DC adapter 324 and a direct current transformer 326. The alternating current provided by the AC socket can be transformed into the direct current at the AC/DC adapter 322. The voltage of the direct current can be transformed to be as same as the charging voltage of the rechargeable battery 100 at the direct current transformer 324. The transformed direct current could be sent to the alterable battery charger 200 via the wire 310 and the second interface 312.

The distance between conductive pieces of the alterable battery charger could be altered manually to fit different kinds of rechargeable batteries, thus the alterable battery charger could charge different kinds of rechargeable batteries and can be charged by computer. The alterable battery charger does not have a built-in AC/DC adapter, thus the volume of the alterable battery charger could be highly reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An alterable battery charger for charging a rechargeable battery, wherein the rechargeable battery has a first electrode and a second electrode, the alterable battery charger comprising:
a clamp for clamping the rechargeable battery;
a first interface disposed on the clamp to connect to an external power;
two conductive pieces disposed in the clamp, wherein at least one of the conductive pieces is pivoted on the clamp, and the alterable battery charger does not have a built-in AC/DC adapter.

2. The alterable battery charger of claim 1, further comprising a printed circuit board disposed in the clamp and connecting to the first interface and the conductive pieces.

3. The alterable battery charger of claim 2, further comprising a plurality of light-emitting devices disposed on a surface of the clamp, wherein the light-emitting devices are controlled by the printed circuit board.

4. The alterable battery charger of claim 3, wherein the printed circuit board comprises a first protect circuit connecting to the first interface and the conductive pieces to prevent the rechargeable battery from overcharging or over discharging.

5. The alterable battery charger of claim 2, wherein the printed circuit board comprises a switch circuit connecting to the first interface and the conductive pieces to determine the electricity of the first electrode and the second electrode and switch the electricity of the conductive pieces.

6. The alterable battery charger of claim 2, wherein the printed circuit board comprises a second protect circuit connecting to the conductive pieces to prevent the conductive pieces from short circuit.

7. The alterable battery charger of claim 1, wherein the first interface comprises a universal serial bus plug or a mini universal serial bus plug.
